(19) United States
(12) Patent Application Publication
(10) Pub. No.: US 2015/0240100 A1
(43) Pub. Date: Aug. 27, 2015

(54) SILVER NANOPARTICLE INKS WITH GELLING AGENT FOR GRAVURE AND FLEXOGRAPHIC PRINTING

(71) Applicant: XEROX CORPORATION, NORWALK, CT (US)

(72) Inventors: Ping Liu, Mississauga (CA); Naveen Chopra, Oakville (CA); Matthew A. Heuft, Oakvill (CA); Yiliang Wu, Oakville (CA)

(73) Assignee: XEROX CORPORATION, NORWALK, CT (US)

(21) Appl. No.: 14/188,256

(22) Filed: Feb. 24, 2014

(51) Int. Cl. C09D 11/00

(52) U.S. Cl. CPC C09D 11/52

(57) ABSTRACT

A silver nanoparticle conductive ink includes silver nanoparticles, a gelling agent, one or more non-polar organic solvents, and optionally a binder. The conductive ink is used for gravure and flexographic printing.

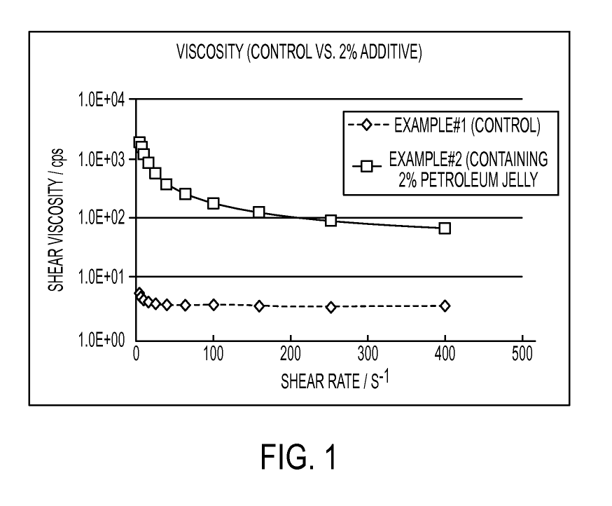

### TECHNICAL FIELD

This disclosure is generally directed to conductive inks. More specifically, this disclosure is directed to conductive inks having silver nanoparticles and a gelling agent for gravure and flexographic printing, and methods for producing such conductive inks.

### BACKGROUND

Conventional conductive silver inks used for offset printing technology include silver particles, carrier solvent(s), and polymer binder(s). Gravure and flexography processes could be an efficient way to manufacture a number of conductive components with low cost. However, some of the main limitations with current gravure and flexography inks include poor conductivity and poor resolution.

The poor conductivity is generally due to poor contact among conductive silver particles in the printed films. In practice, this problem is addressed by increasing the thickness in the prints. However, this translates into more materials being deposited onto the substrate, which increases the cost and the need for more solvent as well. Increased solvent slows down the curing step and, as such, slows down the printing speed. Higher printing speed is an advantage of a roll-to-roll process when compared to batch printing such as screen printing.

Current conductive inks including high loading of silver nanoparticles of about 50-70% have a viscosity in the range of 8 to 12 cps. Such low viscosity is usually not sufficient for most gravure and flexography printing processes, which often require a viscosity from about 20 to 1,000 cps.

In view of the above, current silver conductive inks have limited applications for printing high quality electronic circuits such as RFID antennas where high conductivity is required.

There remains a need for conductive inks with high conductivity and good print resolutions for gravure and flexographic printing processes.

### SUMMARY

The following detailed description is of the best currently contemplated modes of carrying out exemplary embodiments herein. The description is not to be taken in a limiting sense, but is made merely for the purpose of illustrating the general principles of the disclosure herein, since the scope of the disclosure herein is best defined by the appended claims.

Various inventive features are described below that can each be used independently of one another or in combination with other features.

Broadly, embodiments of the disclosure herein generally provide a silver nanoparticle conductive ink including silver nanoparticles, a gelling agent, and one or more non-polar organic solvents.

In another aspect of the disclosure herein, a silver nanoparticle conductive ink includes silver nanoparticles, a gelling agent, and a solvent, the ink has a conductivity of from about 1.0×10⁴ (S/cm) to about 4.0×10⁵ (S/cm).

In yet another aspect of the disclosure herein a silver nanoparticle conductive ink includes silver nanoparticles, a gelling agent, and a solvent, wherein the ink has a viscosity of from about 20 cps to about 1000 cps.

### BRIEF DESCRIPTION OF THE FIGURE

Various embodiments of the present disclosure will be described herein below with reference to the following FIGURES wherein:

The FIGURE illustrates a plot of shear viscosity (in centipose) versus shear rate (in s⁻¹) showing the results of comparative examples between a control silver nanoparticle ink and a silver nanoparticle ink with gelling agent according to the present disclosure.

### DETAILED DESCRIPTION

In the present disclosure, the terms “a,” “an,” and “the” include plural forms unless the content clearly dictates otherwise.

In the present disclosure, ranges disclosed herein include, unless specifically indicated, all endpoints and intermediate values.

In the present disclosure, the term “optional” or “optionally” refer, for example, to instances in which subsequently described circumstances may or may not occur, and include instances in which the circumstance occurs and instances in which the circumstance does not occur.

In the present disclosure, the phrases “one or more” and “at least one” refer, for example, to instances in which one of the subsequently described circumstances occurs, and to instances in which more than one of the subsequently described circumstances occurs.

In the present disclosure, the term “about” used in connection with a quantity is inclusive of the stated value and has the meaning dictated by the context (for example, it includes at least the degree of error associated with the measurement of the particular quantity). When used in the context of a range, the term “about” should also be considered as disclosing the range defined by the absolute values of the two endpoints. For example, the range “from about 2 to about 4” also discloses the range “from 2 to 4.

In the present disclosure, the term “printing” refers to any coating technique capable of forming a conductive ink into a desired pattern on a substrate. Examples of suitable techniques include, for example, spin coating, blade coating, rod coating, dip coating, lithography or offset printing, gravure, flexography, screen printing, stencil printing, and stamping such as microcontact printing.

In the present invention, the term “nano” as used in “silver nanoparticles” refers to, for example, a particle size of less than about 100 nm, for example, from about 0.5 nm to about 100 nm, or from about 1 nm to about 50 nm, or from about 1 nm to about 20 nm. The particle size refers to the average diameter of the metal particles, as determined by transmission electron microscopy (TEM) or other suitable method.

The present disclosure generally provides a conductive ink including silver nanoparticles, a gelling agent(s), a non-polar organic solvent(s), and optionally a binder(s). The conductive ink herein may be suitable for gravure and flexographic printing. The present disclosure also provides methods for producing such conductive inks.

The conductive ink herein may be made by any suitable method. One exemplary method is to disperse the silver nanoparticles in a gelling agent and then dissolving them with a solvent(s) and optionally with a binder(s) under inert bubbling. Then the solvent can be removed by heating and the resulting ink shaken and rolled to ensure mixing.

The conductive ink can be used to form conductive features on a substrate by printing. The printing may be carried out by depositing the ink on a substrate using any suitable printing technique, for example, gravure, rotogravure, flexography, lithography, etching, or screen printing.

The substrate upon which the conductive ink is deposited may be any suitable substrate including, for example, silicon, glass plate, plastic film, sheet, fabric, or paper. For structurally flexible devices, plastic substrates such as polyester, polycarbonate, polyimide sheets and the like may be used.

Following printing, the patterned deposited conductive ink can be subjected to a curing step. The curing step can be a step in which substantially all of the solvent of the conductive ink is removed and the ink is firmly adhered to the substrate.

Annealing the silver ink to the substrate can be done by any suitable means in the art. In an exemplary embodiment, the substrate is heated at a temperature in the range of about 50° C. to about 300° C. In another exemplary embodiment, the substrate is heated at a temperature in the range of about 100° C. to 250° C. The substrate is heated over a time period in the range of about 10 to about 30 minutes.

The printing and annealing steps may be generally performed in an ambient environment. Generally, an ambient environment refers to a normal atmospheric air environment, not requiring the presence of an inert gas environment. In addition, the printing and annealing steps can be performed simultaneously or consecutively.

### Silver Nanoparticles

According to embodiments herein, the silver nanoparticles can have a diameter in the submicron range. Silver nanoparticles herein can have unique properties when compared to silver flakes. For example, the silver nanoparticles herein can be characterized by enhanced reactivity of the surface atoms, high electric conductivity, and unique optical properties. Further, the silver nanoparticles can have a lower melting point and a lower sintering temperature than silver flakes.

Due to their small size, silver nanoparticles herein exhibit a melting point as low as 700° C. below silver flakes. For example, silver nanoparticles may sinter at 120° C. which is more than 800° C. below the melting temperature of bulk silver. This lower melting point is a result of comparatively high surface-area-to-volume ratio in nanoparticles, which allows bonds to readily form between neighboring particles. The large reduction in sintering temperature for nanoparticles enables forming highly conductive traces or patterns on flexible plastic substrates, because the flexible substrates of choice can melt or soften at relatively low temperature (for example, 150° C.).

The silver nanoparticles herein may be elemental silver, a silver alloy, a silver compound, or combination thereof. In embodiments, the silver nanoparticles may be a base material coated or plated with pure silver, a silver alloy, or a silver compound. For example, the base material may be copper flakes with silver plating.

Examples of useful silver compounds include silver oxide, silver thiocyanate, silver cyanide, silver cyanate, silver carbonate, silver nitrate, silver nitrite, silver sulfate, silver phosphate, silver perchlorate, silver tetrafluoroborate, silver acetylacetonate, silver acetate, silver lactate, silver oxalate and derivatives thereof. The silver alloy may be formed from at least one metal selected from Au, Cu, Ni, Co, Pd, Pt, Ti, V, Mn, Fe, Cr, Zr, Nb, Mo, W, Ru, Cd, Ta, Re, Os, Ir, Al, Ga, Ge, In, Sn, Sb, Pb, Bi, Si, As, Hg, Sm, Eu, Th Mg, Ca, Sr and Ba, but not particularly limited to them.

In embodiments, the silver compound may include either or both of (i) one or more other metals and (ii) one or more non-metals. Suitable other metals include, for example, Al, Au, Pt, Pd, Cu, Co, Cr, In, and Ni, particularly the transition metals, for example, Au, Pt, Pd, Cu, Cr, Ni, and mixtures thereof. Exemplary metal composites include Au—Ag, Ag—Cu, Au—Ag—Cu, and Au—Ag—Pd. Suitable non-metals in the metal composite include, for example, Si, C, and Ge.

In embodiments, the silver nanoparticles are composed of elemental silver.

The silver nanoparticles herein may have an average particle size, for example, from about 0.5 to about 100.0 nm, or from about 1.0 to about 50.0 nm, or from about 1.0 to about 20.0 nm.

The silver nanoparticles herein may have any shape or geometry. In certain embodiments, the silver nanoparticles may have a spherical shape.

The silver nanoparticles may be present in the conductive ink in an amount, for example, from about 50 to about 95 weight percent, or from about 60 to about 90 weight percent, or from about 70 to about 85 weight percent of the conductive ink.

In embodiments, the silver nanoparticles have a stability (that is, the time period where there is minimal precipitation or aggregation of the nanoparticles) of, for example, at least about 1 day, or from about 3 days to about 1 week, or from about 5 days to about 1 month, or from about 1 week to about 6 months, or from about 1 week to over 1 year.

### Gelling Agent(s)

The conductive ink herein may also include a gelling agent(s). The gelling agent may be used to increase the viscosity of the conductive ink within a desired temperature range. In particular, the gelling agent may form a semi-solid gel in the conductive ink at temperatures below the specific temperature at which the ink composition is jetted. In the semi-solid gel phase, the molecular components of the mixture can be held together by non-covalent bonding interactions such as hydrogen bonding, Van der Waals interactions, aromatic non-bonding interactions, ionic or coordination bonding, and/or London dispersion forces. Upon stimulation by physical forces, such as temperature or mechanical agitation or chemical forces such as pH or ionic strength, the gelling agent can reversibly transition from liquid to semi-solid state at the macroscopic level.

The gelling agent may be able to dissolve in a solvent described below. In addition, the gelling agent may be able to form gels with the silver nanoparticles and the solvent.

The gelling agent may be chosen to give the appropriate wettability to the silver nanoparticles. In embodiments, the gelling agent may be a thermal reversible gelling agent (i.e., is converted into a liquid by heating and becomes a gel again upon cooling). Any thermal reversible gelling agent capable of gelling the conductive ink may be suitable for the present disclosure. The thermal reversible gelling agent may be, for example, petroleum jelly; paraffin wax; or linear hydrocarbons such as hexadecane and octadecane.

The gelling agent may be present in the conductive ink in an amount, for example, from about 0.25 to about 5.0 weight percent, or from about 0.5 to about 3.0 weight percent, or from about 1.0 to about 2.0 weight percent of the conductive ink.

### Solvent(s)

The conductive ink herein may also include a solvent(s), such as a non-polar organic solvent(s). The solvent may be used as a vehicle for dispersion of the silver nanoparticles to minimize or prevent the silver nanoparticles from agglomerating and/or optionally providing or enhancing the solubility or dispersiblity of silver nanoparticles.

Suitable non-polar organic solvents for silver nanoparticle conductive inks herein include, for example, hydrocarbons such as an alkane; an alkene; an alcohol having from about 10 to about 18 carbon atoms such as, undecane, dodecane, tridecane, tetradecane, hexadecane, hexadecane, 1-undecanol, 2-undecanol, 3-undecanol, 4-undecanol, 5-undecanol, 6-undecanol, 1-dodecanol, 2-dodecanol, 3-dodecanol, 4-dodecanol, 5-dodecanol, 6-dodecanol, 1-tridecanol, 2-tridecanol, 3-tridecanol, 4-tridecanol, 5-tridecanol, 6-tridecanol, 7-tridecanol, 1-tetradecanol, 2-tetradecanol, 3-tetradecanol, 4-tetradecanol, 5-tetradecanol, 6-tetradecanol, 7-tetradecanol, and the like; an alcohol, such as for example, terpineol (α-terpineol), β-terpineol, geraniol, cineol, cedral, linalool, 4-terpineol, lavandulol, citronellol, nerol, menthol, borneol, hexanol, heptanol, cyclohexanol, 3,7-dimethylocta-2,6-dien-1ol, 2-(2-propyl)-5-methyl-cyclohexane-1-ol; isoparaffinic hydrocarbons such as, for example, isodecane, isododecane; commercially available mixtures of isoparaffins such as ISOPAR E®, ISOPAR C®, ISOPAR H®, ISOPAR L®, ISOPAR V® and ISOPAR M® all manufactured by Exxon Chemical Company; SHELLSOL® manufactured by Shell Chemical Company; SOLTROL® manufactured by Philips Oil Co., Ltd.; BEGASOL® manufactured by Mobil Petroleum Co., Inc.; IP Solvent 2835 made by Idemitsu Petrochemical Co., Ltd; naphthenic oils; aromatic solvents, such as benzene, nitrobenzene, toluene, ortho, meta, and para-xylene, and mixtures thereof; 1,3,5-trimethylbenzene (mesitylene); 1,2-, 1,3- and 1,4-dichlorobenzene and mixtures thereof; trichlorobenzene; cyanobenzene; phenylcyclohexane and tetralin aliphatic solvents, such as hexane, heptane, octane, isooctane, nonane, decane, dodecane; cyclic aliphatic solvents, such as: bicyclohexyl and decalin.

In embodiments, two or more non-polar organic solvents may be used.

The non-polar organic solvent(s) may be present in the conductive ink in an amount, for example, from about 5.0 to about 50.0 weight percent, or from about 10.0 to about 40.0 weight percent, or from about 10.0 to about 30.0 weight percent of the conductive ink.

### Binder(s)

The conductive ink may also include a binder(s), such as polymer binder(s). The binder may act as an adhesion promoter to facilitate the adhesion of the conductive ink to a wide variety of substrates and also to increase the stability of the ink, such as by extending the shelf life of the ink.

The binder(s), such as polymer binder(s), may have a high viscosity (>10⁶ cPs at room temperatures) to allow the conductive ink to retain the pattern following printing. The binder(s) may have a weight average molecular weight (Mw) of about 10,000 to about 600,000 Da, or from about 40,000 to about 300,000 Da, or from about 40,000 to about 250,000 Da.

The polymer binder may be, for example, a polyvinylbutyral (PVB) terpolymer; polyesters such as terephthalates, terpenes, styrene block; copolymers such as styrene-butadiene-styrene copolymer, styrene-isoprene-styrene copolymer, styrene-ethylene/butylene-styrene copolymer, and styrene-ethylene/propylene copolymer; ethylene-vinyl acetate copolymers; ethylene-vinyl acetate-maleic anhydride terpolymers; ethylene butyl acrylate copolymer; ethylene-acrylic acid copolymer; polymethylmethacrylate; polyethylmethacrylate; poly(alkyl)methacrylates; polyolefins; polybutene, polyamides; and mixtures thereof.

In embodiments, the polymer binder is a PVB terpolymer. Examples of useful PVB terpolymers include, for example, polymers manufactured by MOWITAL® (Kuraray America), S-LEC® (Sekisui Chemical Company), BUTVAR® (Solutia).

The ink herein may have a viscosity of from about 20 cps to about 1000 cps, or from about 30 cps to about 750 cps, or from 40 cps to about 500 cps, or from 50 cps to about 300 cps. The inks herein may have a conductivity of from about 1.0×10⁴ S/cm to about 4.0×10⁵ S/cm, or from about 1.5×10⁴ S/cm to about 3.5×10⁵ S/cm, or from about 2×10⁴ S/cm to about 3×10⁵ S/cm. In embodiments, the inks herein can have a conductivity of about 3.5×10⁴S/cm.

### Example

The following Example illustrates one exemplary embodiment of the present disclosure. This Example is intended to be illustrative only to show one of several methods of preparing the conductive ink and is not intended to limit the scope of the present disclosure. Also, parts and percentages are by weight unless otherwise indicated.

In this Example, two sample inks were prepared. The first sample included silver nanoparticles mixed with an organic solvent and without a gelling agent. The second sample included silver nanoparticles mixed with an organic solvent and a gelling agent.

### Example#1

### Silver Nanoparticle Ink Control without Gelling Agent

A silver nanoparticle ink including 71 wt % of silver nanoparticle loading in mixed organic solvents of decalin and toluene (40/60 wt %) was prepared as follows: 5.88 g of a silver nanoparticle wetcake was dissolved in 0.67 g of toluene and then bubbled with argon gas for about 5 hours to remove volatiles such as methanol. Then, the amount of toluene lost during the bubbling process was added back to ensure accurate solvent composition. After the volatiles were removed, 0.45 g of decalin was added and the resulting ink was shaken for about 2 hours and then rolled overnight to ensure good mixing. The resulting conductive silver nanoparticle ink contained a silver content of 65 wt %, which was determined by removing all the solvents and organic stabilizer at a hot plate (˜250° C.) for 20 minutes. The viscosity of the ink was 3.3 cps and the conductivity of a spin-coated film on a glass slide was 3.7×10⁴ S/cm, measured by 4-point-probe conductivity measurement.

It was noted that the viscosity of the first sample was rather low and such low viscosity is not suitable for most gravure based printing processes.

### Example#2

### Silver Nanoparticle Ink Containing 2 wt % of a Gelling Agent

A silver nanoparticle ink with 71 wt % of silver nanoparticle loading with 2 wt % of petroleum jelly in a mixture of decalin and toluene solvents (40/60 wt %) was prepared in a similar manner as Example 1, except that 2 wt % of petroleum jelly was added to the ink system. In this example, the petroleum jelly was dissolved in the toluene and then added to the ink. The resulting conductive silver nanoparticle ink contained a silver content of ˜65 wt %, which was determined by removing all the solvents and organic stabilizer at a hot plate (˜250° C.) for 20 min. The viscosity of the ink was ˜65 cps and the conductivity of a spin-coated film on a glass slide was 3.5×10⁴ S/cm, measured by 4 point probe conductivity measurement.

These two examples demonstrate that the ink viscosity is significantly increased from 3.3 cps to 65 cps by adding a small amount of gelling agent such as petroleum jelly. Furthermore, such small amounts of gelling agent do not affect conductivity of an annealed film.

Table 1 shows the results of the conductivity of the examples.

TABLE 1

| Sample | Conductivity (S/cm) |
|---|---|
| Example#1 | 3.7 × 10⁴ |
| Example#2 | 3.5 × 10⁴ |

The FIGURE shows viscosity curves for a control ink (Example#1) and a silver nanoparticle ink with gelling agent (Example#2) according to the present disclosure. As can be seen from the FIGURE, the Example#2 (with gelling agent) exhibits a higher viscosity as compared with Example#1 (control).

### Example#3

### Printing Tests (Flexi-Proof Coating) of a Silver Nanoparticle Conductive Ink Containing 4 wt % Gelling Agent

A sample of ink containing 4 wt % petroleum jelly was prepared in a manner similar to the second example (Example#2), and was coated onto a Digital Color Elite Gloss paper (DCEG paper) and to a PET (polyethylene terepthlate) plastic substrate using a Flexi-proof printer (RK Printcoat Instruments, Royston, UK) and annealed at 130° C. for 30 minutes. Two coating weights were applied to each substrate (the anilox roll coating densities were 18 cm³/m² and 13 cm³/m² respectively). The coated films' conductivities were measured using a 2-point-probe ohmmeter. The average thickness of the coated films (0.65 um) was determined by SEM-this value was used to calculate an approximate resistivity from the measured sheet resistance.

Table 2 shows the results of the resistivity and conductivity on each substrate.

TABLE 2

| | | Sheet Resistance (Ω/□) | | Average | Resistivity (Ω · cm) | | Conducttivity (S/cm) | |
|---|---|---|---|---|---|---|---|---|
| | | 18 cm³/m² | 13 cm³/m² | Thickness | 18 cm³/m² | 13 cm³/m² | 18 cm³/m² | 13 cm³/m² |
| Sample | Substrate | patch | patch | (μm) | patch | patch | patch | patch |
| Example #3 | DCEG | 0.46 | 0.50 | 0.65 um | 3 × 10⁻⁵ | 3.25 × 10⁻⁵ | 3.3 × 10⁴ | 3.1 × 10⁴ |
| Example #3 | PET | 0.45 | 0.63 | 0.65 um | 2.9 × 10⁻⁵ | 4.1 × 10⁻⁵ | 3.4 × 10⁴ | 2.4 × 10⁴ |

It will be appreciated that variations of the above-disclosed and other features and functions, or alternatives thereof, may be desirably combined into many other different systems or applications. Also that various, presently unforeseen or unanticipated, alternatives, modifications, variations or improvements therein may be subsequently made by those skilled in the art which are also intended to be encompassed by the following claims.

What is claimed is:

1. A silver nanoparticle conductive ink, comprising:
silver nanoparticles;
a gelling agent; and
one or more non-polar organic solvents.

2. The silver nanoparticle conductive ink according to claim 1, wherein the silver nanoparticles have an average size of about 10 nm or less.

3. The silver nanoparticle conductive ink according to claim 1, wherein silver nanoparticles comprise an amount of from about 50.0 to about 95.0 weight percent of the conductive ink.

4. The silver nanoparticle conductive ink according to claim 1, wherein the gelling agent comprises a thermal reversible gelling agent.

5. The silver nanoparticle conductive ink according to claim 1, wherein the gelling agent is selected from the group consisting of petroleum jelly, paraffin wax, hexadecane, and octadecane.

6. The silver nanoparticle conductive ink according to claim 1, wherein the gelling agent comprises an amount of from about 0.25 to about 5.0 weight percent of the conductive ink.

7. A silver nanoparticle conductive ink, comprising:
silver nanoparticles;
a gelling agent; and
a solvent,
wherein the ink has a conductivity of from about 1.0×10⁴ (S/cm) to about 4.0×10⁵ (S/cm).

8. The silver nanoparticle conductive ink according to claim 7, wherein the silver nanoparticle comprises elemental silver.

9. The silver nanoparticle conductive ink according to claim 7, wherein silver nanoparticles comprise an amount of from about 50.0 to about 95.0 weight percent of the conductive ink.

10. The silver nanoparticle conductive ink according to claim 7, wherein the silver nanoparticles have an average particle size from about 0.5 to about 100.0 nm.

11. The silver nanoparticle conductive ink according to claim 7, wherein the silver nanoparticles have a spherical shape.

12. The silver nanoparticle conductive ink according to claim 7, wherein the solvent comprises a non-polar organic solvent.

13. The silver nanoparticle conductive ink according to claim 7, wherein the solvent is selected from the group consisting of aromatic solvents including benzene, nitrobenzene, toluene, ortho-, meta-, and para-xylene, and mixtures thereof; 1,3,5-trimethylbenzene (mesitylene); 1,2-, 1,3- and 1,4-dichlorobenzene and mixtures thereof; trichlorobenzene; cyanobenzene; phenylcyclohexane; tetralin; aliphatic solvents including hexane, heptane, octane, isooctane, nonane, decane, dodecane, and Isopar; cyclic aliphatic solvents including bicyclohexyl, decalin; a cyclic terpene; cyclodecene; 1-phenyl-1-cyclohexene; 1-tert-butyl-1-cyclohexene; and mixtures thereof.

14. The silver nanoparticle conductive ink according to claim 7, wherein the solvent is present an amount of from about 5.0 to about 50.0 weight percent of the conductive ink.

15. A silver nanoparticle conductive ink comprising:
silver nanoparticles;
a gelling agent;
a solvent; and
an optional binder,
wherein the ink has a viscosity of from about 20 cps to about 1000 cps.

16. The silver nanoparticle conductive ink according to claim 15, wherein binder has a weight average molecular weight (Mw) of from about 10,000 to about 600,000 Da.

17. The silver nanoparticle conductive ink according to claim 12, wherein the binder is selected from the group consisting of polyvinylbutyral (PVB) terpolymer, terephthalates, terpenes, styrene block, styrene-butadiene-styrene copolymer, styrene-isoprene-styrene copolymer, styrene-ethylene/butylene-styrene copolymer, styrene-ethylene/propylene copolymer, ethylene-vinyl acetate copolymers, ethylene-vinyl acetate-maleic anhydride terpolymers, ethylene butyl acrylate copolymer, ethylene-acrylic acid copolymer, polymethylmethacrylate, polyethylmethacrylate, poly(alkyl)methacrylates, polyolefins, polybutene, polyamides, and mixtures thereof.

18. The silver nanoparticle conductive ink according to claim 15, wherein the solvent comprises a non-polar organic solvent.

19. The silver nanoparticle conductive ink according to claim 15, wherein the ink has a conductivity of 1.0×10⁴ (S/cm) to about 4.0×10⁵ (S/cm).
